(19) United States
(12) Patent Application Publication
(10) Pub. No.: US 2016/0378998 A1
(43) Pub. Date: Dec. 29, 2016

(54) SYSTEM CONFIGURATIONS FOR ENCRYPTION OF CONTEST DATA PARTS

(71) Applicant: Erybo Incorporated, Cambridge, MA (US)

(72) Inventors: George Brintalos, Athens (GR); Konstantinos Chalkias, Athens (GR)

(21) Appl. No.: 15/179,687

(22) Filed: Jun. 10, 2016

Related U.S. Application Data
(60) Provisional application No. 62/183,496, filed on Jun. 23, 2015.

(51) Int. Cl. G06F 21/60; H04L 9/08

(52) U.S. Cl. CPC G06F 21/602; H04L 9/0833

(57) ABSTRACT

A method for organizing a secure multi-participant online contest is disclosed. The method includes creating encrypted contest data parts with a set of encryption keys that have a corresponding set of decryption keys. The contest starting time is announced and the encrypted contest data parts are made available to a group of contest participants. The decryption keys are transmitted to the contest participants in accordance to a contest time flow. In some examples, the encrypted contest data parts allows for contests that include multi-step and multi-part questions.

### CROSS-REFERENCE TO RELATED APPLICATIONS

This application claims priority to U.S. Provisional Patent App. No. 62/183,496 entitled “A METHOD FOR ORGANIZING A SECURE MULTI-PARTICIPANT CONTEST,” filed on Jun. 23, 2015, the entirety of which is herein incorporated by reference.

### BACKGROUND OF THE INVENTION

1. Field

The present invention relates generally to organizing a multi-participant online contest, and more specifically, to a method that increases the security and fairness of a contest, including contests made up of multi-step and multi-part questions and large data sets without sacrificing the user experience for participants.

2. Description of Related Art

By utilizing computer networks, contests can be held between participants in different locations. These multi-participant online contests can take many forms, including a single question and an answer where each answer corresponds to a single question. Another format utilizes a multi-step or multi-part question where a single question contains multiple steps or parts. For example, a question may include multiple parts such as a prompt, audio, video, or diagram. Also, an online contest may run in a synchronous mode (simultaneous participation) or asynchronous mode (users each take the test independently from one another).

In one approach for organizing an online contest, the entire contest data, including both the questions and answers for the entire contest, is made available to participants prior to the start of the contest. The entire contest's data, including answers, may be transmitted a-priori over an unencrypted medium. However, an approach that makes available the entire contest data for download can introduce fairness issues by introducing the risk that dishonest participants can game the contest by decoding the answers prior to being asked the questions. Even if answers are not available with the contest data, malicious users may search for answers by consulting a reference, such as the Internet, for answers to upcoming questions. The “timing” advantage for each question in the sequence is related to the number of questions that precede it. Thus, the larger the index of questions, the greater the advantage a malicious user gains for each additional question. Even if only data “heavy” portions of the contest are transmitted, such as multimedia data, and not the actual questions, malicious users may still gain an advantage by having partial advanced knowledge on what the question references. For instance, when sending a photo associated with a question but withholding the textual portion of the question, a malicious user can typically extract information on what is actually being asked.

In another approach for organizing an online contest, the answer to each question is transmitted only when all participants have submitted an answer. Once users are locked into their answers, the correct answer is transmitted to each participant. While this method prevents participants from scanning ahead to decode the correct answer, it may introduce additional performance issues. For example, downloading contest data while running the contest may introduce performance issues for any participant whose network connection cannot sustain the download requirements. This method favors contest participants with faster and more reliable network connections. This concept also applies to an asynchronous contest mode, for example, when the next question becomes available after the previous has been answered/finished (from that specific user). If a contest runs asynchronously, “fast” users will have a better user experience, especially when the downloaded part includes “heavy” data (e.g., multimedia data).

In another approach for organizing an online contest, the data sent is encrypted but with a single encryption key. When the contest starts, the decryption key is transmitted, but its access allows for decrypting the entire contest content. Dishonest users have access to every question, bypassing the original contest time flow sequence.

Apart from the protocol related to submitting contest data, network topology and methods of timing measurements can play a role in maintaining transparency and fairness. Regarding timing, some applications use the client's timer to keep track of response time. This method allows the time to be easily altered (either in-device or by altering the submitted network packet). In an offline mode, the contest is first downloaded or already stored on the device, and then playable without an available network connection. When the user is connected back to the network, for example, the Internet, all answers are transmitted to contest host servers. However, the time-stamp associated with all answers may be corrupted by the client's clock. Relying on client's timer without any interaction with server timers may create cheating opportunities.

Network topology may also impact the accuracy of timing measurements. As an example, a host runs a contest from a US-based server and there are two participants with equal network quality and speed, one in Australia and one in USA. Due to the inherent network latency, even if timing measurements are taken from the host-server, it is highly possible that the US-client will experience faster response times than the Australian one.

Consequently, there exists a need for an efficient and secure method for organizing a multi-participant online contest.

### BRIEF DESCRIPTION OF THE DRAWINGS

Various embodiments of the invention are disclosed in the following detailed description and the accompanying drawings.

FIG. 1 is a flow chart illustrating prior art methods for organizing an online contest and their disadvantages.

FIG. 2A is a block diagram of an example of an online contest hosting environment utilizing a content delivery network.

FIG. 2B is a flow chart illustrating an embodiment of a method for organizing a secure online contest utilizing a content delivery network.

FIG. 3 is a flow chart illustrating an embodiment of a method for organizing a secure online contest utilizing an event-release or timed-released policy.

FIG. 4 is a block diagram illustrating an example of splitting a challenge question into multiple parts.

### DETAILED DESCRIPTION

The methods and systems described herein relate to methods and systems for organizing a secure multi-participant online contest. In some examples, the method may include utilizing a set of encryption keys to encrypt each part or step of the contest data, announcing the contest starting time, making available for distribution the encrypted contest data parts to contest participants, and transmitting to contest participants each corresponding decryption key in accordance to a contest time flow. In some examples, the contest participants may only decrypt each contest part or step of the contest when the corresponding decryption key is made available. In some examples, the contest time flow is based on an event-release policy. In some examples, the contest time flow is based on a timed-release policy.

The invention can be implemented in numerous ways, including as a process; an apparatus; a system; a hardware virtualization; a software virtualization; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. It should be recognized, however, that such description is not intended as a limitation on the scope of the present disclosure but is instead provided as a description of various examples. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

The system described herein applies to single or multiple online participants. The participants can be in separate locations using heterogeneous devices and connect via a collection of interconnected networks using a network connection. Examples of networks include the Internet, local-area networks, and peer to peer networks. Examples of network connections include relying on Ethernet, Wi-Fi, and cellular connections.

The system described herein applies to single-step and multi-step contests as well as synchronous and asynchronous access to contest data. In a typical contest, each participant is presented with N challenge questions to be answered. In a single-step contest, the participants are given access to the whole set of N challenge questions at the beginning of the contest. Some real world single-step contest examples include national examinations and driver's license exams, where examinees are provided with the whole set of questions and are given a certain amount of time to complete the test.

In contrast, in a multi-step contest, there is a well-defined contest time flow for step-by-step access to the challenge questions. Typically, but not necessarily, the contest time flow allows for sequential access to each step of the contest. In a multi-step contest, there is a time flow that defines when each participant may access the next challenge question (or next group of questions). In some embodiments, the contest time flow is based on a completing event such as completing the previous challenge question or when a time-out is exceeded. An example of a multi-step contest is a language exam that consists of several distinct parts (e.g., listening, reading comprehension, writing, etc.) where each part must be completed sequentially and access to the next part is only available when the previous part has been completed. Similarly, in some embodiments, each step can also be split further if the step includes distinct parts.

In some embodiments, a multiple choice quiz format may be utilized. Using this format, each question may appear for a certain amount of time and then, on the next step, the possible multiple-choice answers are shown to the participants. A similar scenario is when question hints are provided after a period of time has passed without a participant selecting an answer. In general the multi-step approach can be extended to support any contest time flow for step-by-step access to the contest data.

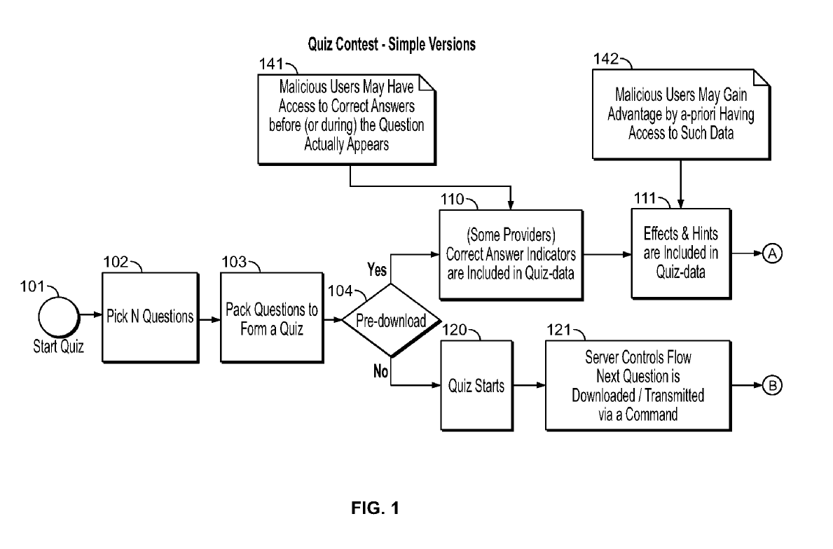

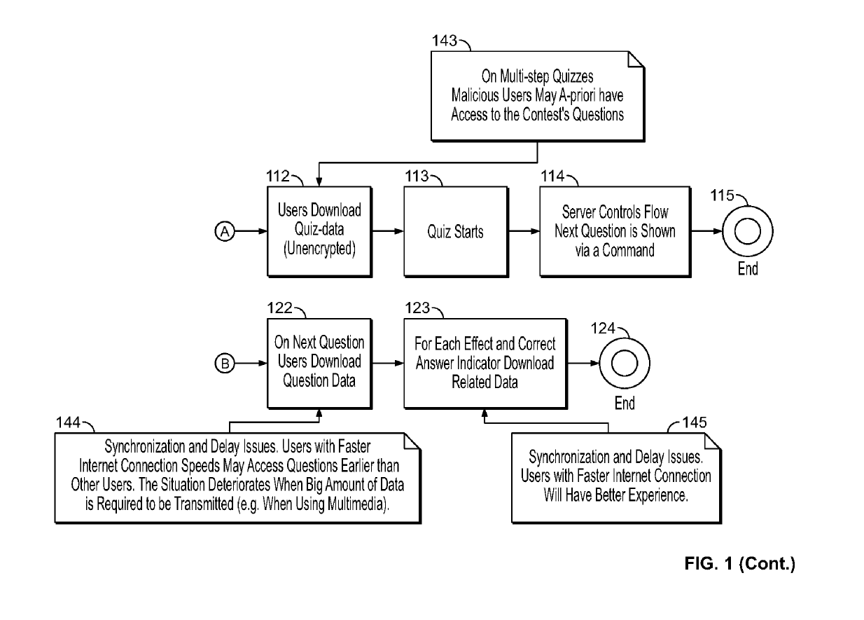

FIG. 1 is a flow chart illustrating two prior art methods for organizing an online contest and the corresponding disadvantages. In the prior art methods, a contest quiz is started at 101. At 102, N challenge questions are selected. At 103, the questions are packed to form the contest data for a contest quiz. At 104, the contest data may be optionally available for pre-download.

If the contest data is available for pre-download at 104, the contest data may include correct answer indicators 110. The quiz contest data may also include effects and hints 111. At 112, the quiz contest data is downloaded by the quiz participants. Typically the contest data is downloaded in an unencrypted format. At 113, the online contest quiz starts. At 114, the contest server controls the flow of the contest by issuing a command to show the next question. The contest flow loops at 114 until there are no more questions. When the questions are completed, the quiz ends 115. This method can create several significant disadvantages. At 110, malicious users may have access to the correct answer before (or during) the period when the question appears 141. At 111, malicious users may gain an advantages by a-priori having access to the contest data such as the effects and hints 142. At 143, malicious users may a-priori access contest questions. These flaws are particularly harmful for multi-step quiz contests and are common unfairness issues impacting most online quiz contests. By transmitting correct answer indicators along with the challenge question, a malicious user can track the correct answer indicators and answer questions correctly. In one of the worst case implementations, a contest organizer transmits the entire challenge data prior to the start of the quiz contest, making the entire set of answers available to potential cheaters. Another potential problem involves transmitting images used for a photo-quiz contest. In this scenario, a malicious user is able to extract information about a subsequent question from images related to that question. When a malicious user has partial or full knowledge of the next challenge question, the user has plenty of time to research the answer to the question prior to being asked the question.

If the contest data is not available for pre-download in 104, the contest may begin at 120 without requiring each participant to download the entire contest data. At 121, the contest server controls the flow of the contest by issuing a command to download or transmit the data for the next question. At 122, participants download data for the next question. At 123, related contest data is downloaded for each effect and correct answer indicator. If there are additional questions, the contest returns to 121 to issue a command to download or transmit the data for the next question. This continues until the contest is over 124. This prior art method has several significant issues. At 122, synchronization and delay issues 144 are introduced. Participants with faster network connections may receive an unfair advantage by having access to questions earlier than other participants. The performance and fairness of the contest deteriorates when a large amount of contest data needs to be transmitted or downloaded. The performance is particularly vulnerable to contests that rely heavily on multimedia and other large data sets. At 123, synchronization and delay issues 145 are again introduced. Contest participants with better network connections will have an advantage over those with poorer connections. The various embodiments set forth solve these security flaws and user-experience inefficiencies.

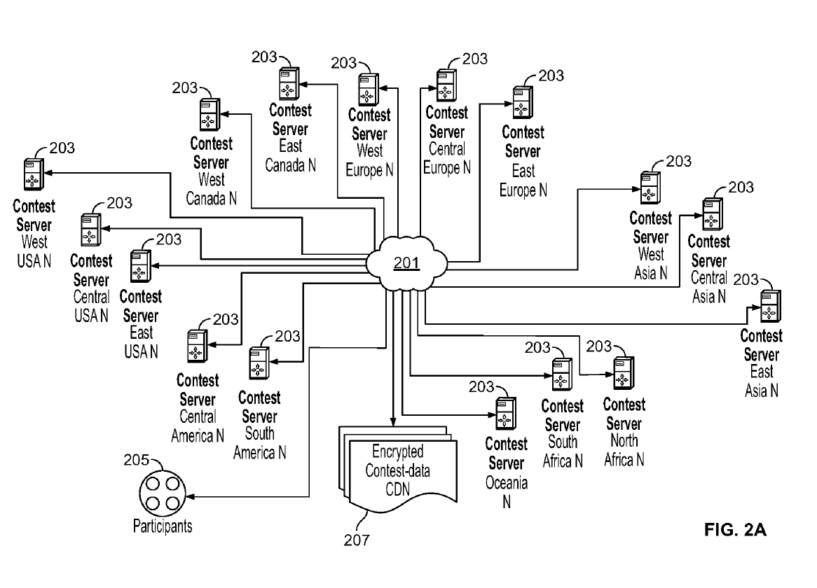

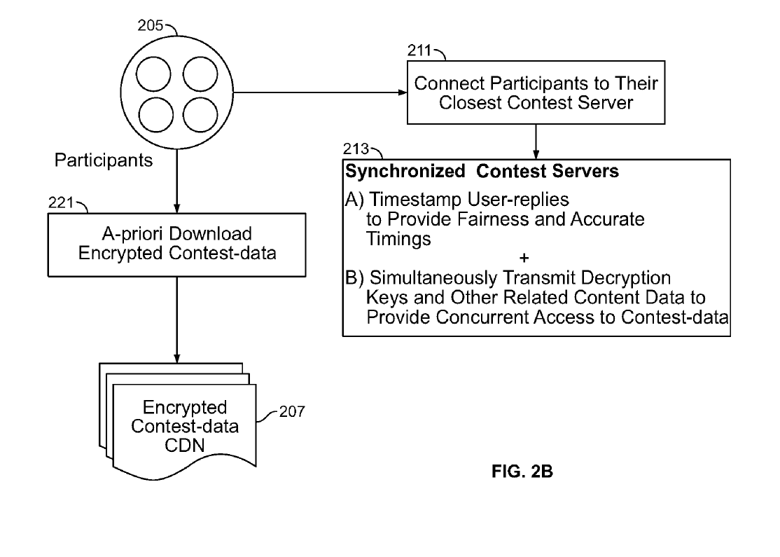

An approach for organizing a multi-participant online contest is described in more detail below with respect to FIG. 2A. In the example shown, contest participants 205 and one or more contest servers 203 are connected to a network 201 and thus to each other. Optionally, a contest data content delivery network (CDN) 207 is also connected to the network 201 for hosting content data. In one embodiment and in the example shown, the contest servers consist of multiple contest servers located in different geographic areas such as East USA, Central USA, and West USA. An example of the network 201 includes the Internet. An example of a participant includes a user with a mobile device, such as a smartphone, tablet, or laptop, running the client contest software. The participant may connect to network 201 using a wireless connection such as Wi-Fi or cellular technology. Examples of the client contest software include mobile phone applications, tablet applications, laptop applications, and web browser-based application. Web browser applications can be customized for the particular device used by the participant. Another example of a participant includes a desktop computer user that connects to the network using the Internet via a network technology such as Ethernet or Wi-Fi.

FIG. 2B is a flow chart illustrating an embodiment of a method for organizing a secure online contest utilizing a content delivery network. In some embodiments, the process of FIG. 2B is implemented at least in part on at least one of the contest servers 203 of FIG. 2A and utilizes the encrypted contest data CDN 207 of FIG. 2A. At 221, each participant a-priori downloads the encrypted contest data from a contest server or optionally an encrypted contest data CDN. Independent of 221, at 211, each participant connects to the closest contest server. In some embodiments, the contest servers are synchronized and may include timestamps in the messages they send, including user-reply messages, to improve fairness and accuracy 213. At 213, the contest servers transmit to each participant one or more decryption keys and other related contest data. By transmitting the decryption keys and data in a synchronized manner, each participant is able to concurrently access the contest data part corresponding to the decryption keys in accordance with the contest time flow.

### Event-Release/Timed-Release Encrypted Quiz/Exam Contest

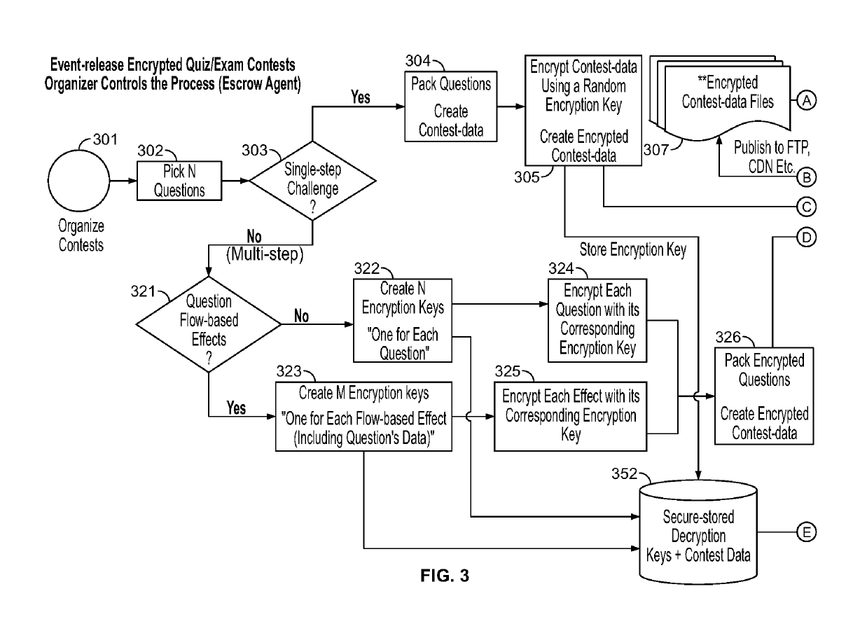

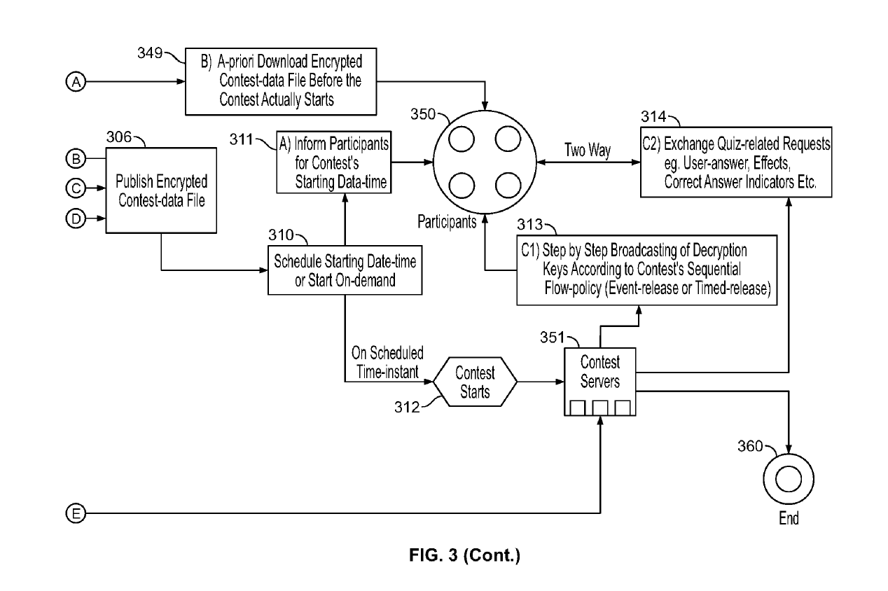

FIG. 3 is a flow chart illustrating an embodiment of a method for organizing a secure online contest utilizing an event-release or timed-release policy. In some embodiments, the process of FIG. 3 is implemented at least in part on at least one of the contest servers 203 of FIG. 2A and utilizes the encrypted contest data CDN 207 of FIG. 2A for hosting contest data. At 301, a contest server organizes and initializes a contest. At 302, N questions are selected for the contest. If the contest is a single-step challenge contest in 303, then the questions are packed to create the contest data at 304. At 305, the single-step challenge contest data is encrypted using a random encryption key to create the encrypted contest data. At 306, the encrypted contest data is published. The encrypted contest data is published via a network protocol such File Transfer Protocol (FTP), SFTP, HTTP, HTTPS, etc., and/or hosted on a service such as a content delivery network (CDN). At 307, the encrypted contest data is hosted at a contest data server. In some embodiments the contest data server performing the hosting of the contest data is different from the server performing the previous steps 301 through 306. In some embodiments, the contest data server utilizes the encrypted contest data CDN 207 of FIG. 2A for hosting contest data.

At 310, the contest server schedules a start time for the contest. Examples of a start time include a date-time start time and an on-demand start time. For a date-time start time, at 311, the contest server informs that contest participants of the contest's starting date-time start time. For an on-demand start time, the contest server schedules the start time to occur based on the demand of the participants and initializes the start of the contest at 312. For a date-time start time, when the date-time configured for the start time is reached, the contest server initializes the start of the contest at 312. Once the contest starts, the contest server 351 progresses through the contest time flow until the contest is complete 360. In some embodiments, the contest server 351 includes at least one of the contest servers 203 of FIG. 2A.

Prior to the contest start 312, the contest participants 350 will have downloaded the encrypted contest data 349 from a contest data server 307. In some embodiments, the contest participants 350 are the contest participants 205 of FIG. 2A. Once the contest starts 312, the contest server 351 will step-by-step broadcast decryption keys according to the contest's sequential contest time flow policy 313 to each of the participants 350. The contest time flow may include an event-release or timed-released policy. In an event-release policy, the next step is triggered by the occurrence of an event, for example, the end of a video would reveal the next step for a challenge question. As another example, an event may be that all of the participants have completed the first part of a challenge question. In a timed-release policy, the next step is triggered by the passage of time. As an example, the next step of a challenge question may be revealed after 30 seconds have passed since displaying a hint. At 314, the contest server 351 and contest participants 350 exchange quiz-related requests including, for example, user answers, effects, correct answer indicators, etc. In some embodiments, the amount of data exchanged at 313 and 314 is small in amount compared to the encrypted contest data files downloaded at 349. By keeping the data exchanged at 313 and 314 small, the contest server minimizes the impact each participant's network connection has on the contest.

If the contest is not a single-step challenge contest in 303, then the contest is a multi-step contest and control proceeds to 321. At 321, if question flow-based effects are not included then at 322, N encryption keys are created. The N encryption keys are created for N contest parts. In some embodiments, each question may be a single part or may contain multiple parts. Once the N keys are created, at 324, each part is encrypted with a corresponding encryption key. If each question is a single part then each challenge question is encrypted with a corresponding encryption key. If a question has multiple parts, each part of the challenge is encrypted with a corresponding encryption key.

At 321, if question flow-based effects are included then at 323 M encryption keys are created. The M encryption keys correspond to one key for each flow-based effect including question data. The flow-based effects require addition keys since each effect utilizes a different key. Once the M keys are created, at 325, each effect is encrypted with the corresponding encryption key.

At 326, the result of 324 or 325 is packed to create a set of encrypted contest data parts. The encrypted contest data is then published at 306 in a similar manner as if the contest was a single-step challenge contest.

The decryption keys corresponding to the encryption keys created in 322 and 323 are stored at a contest key server 352. For a single-step challenge contest, the decryption key corresponding to the encryption key utilized in 305 is stored at 352. The contest server 351 may access or include the contest key server functionality 352. In some embodiments, the contest key server is the contest server 203 of FIG. 2A or may optionally utilize the encrypted contest data CDN 207 of FIG. 2A.

### Splitting a Challenge to Distinct Parts

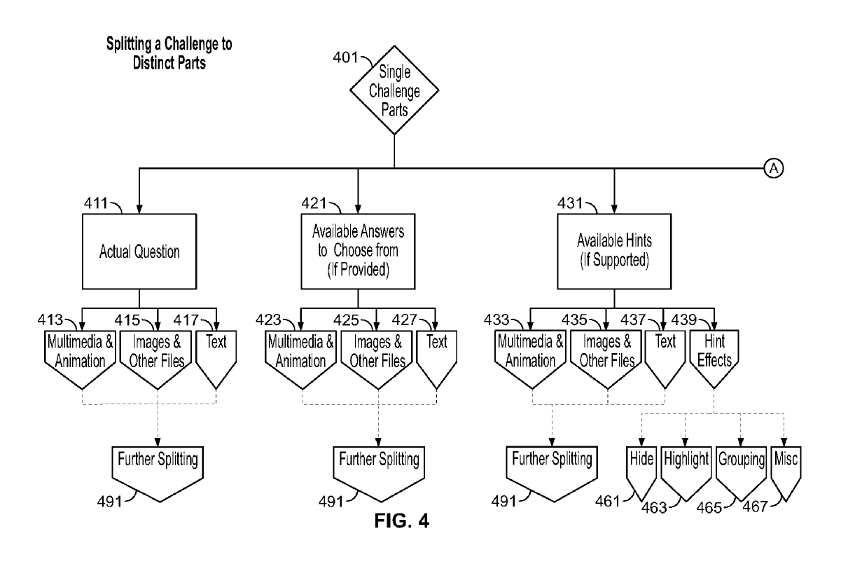

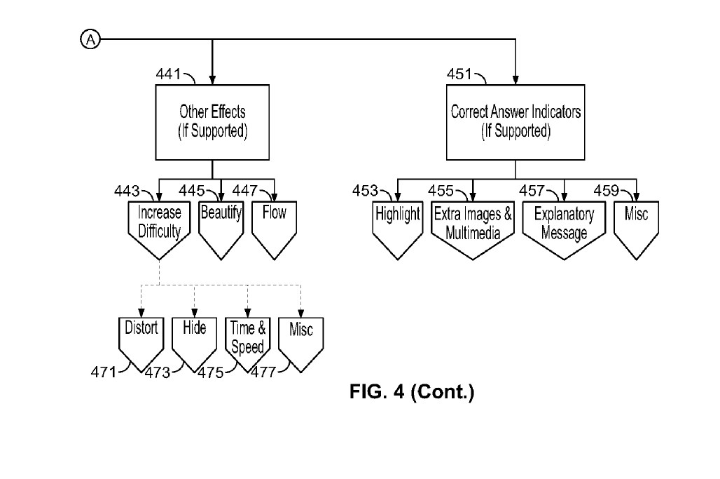

FIG. 4 is a block diagram illustrating an example of splitting a challenge question into multiple parts. In FIG. 4, a single challenge part 401 can be split into multiple parts, including, for example, an actual question 411, available answers to choose from 421, available hints 431, other effects 441, and correct answer indicators 451.

The actual question 411 may include multiple parts such as multimedia and animation 413, images and other files 415, and text 417. Available answers to choose from 421 may include multiple parts such as multimedia and animation 423, images and other files 425, and text 427. Available hints 431 may include multiple parts such as multimedia and animation 433, images and other files 435, text 437, and hint effects 439. Hint effects 439 may further be split and may include multiple parts such as hide 461, highlight 463, grouping 465, and misc. 467. Other effects 441 may include multiple parts such as increase difficulty 443, beautify 445, and flow 447. Increase difficulty 443, may further be split and may include multiple parts such distort 471, hide 473, time & speed 475, and misc. 477. Correct answer indicators 451 may include multiple parts such as highlight 453, extra images & multimedia 455, explanatory message 457, and misc. 459. As shown in FIG. 4, any part with distinct sub-parts allows for further splitting 491.

Splitting is made possible in various manners including splitting a group of questions into multiple parts, splitting a single question into parts, splitting a question from the hints, and splitting the actual question into a question prompt and possible answers. There are numerous advantages to this approach. As an example, by splitting a question from the hints, the contest can provide hints, including multiple levels of hints, for each question only after a participant requests the hint or exceeds a time threshold. By splitting the challenge question into multiple parts or steps, each part or step may be displayed at the appropriate time or event based on the contest time flow. Further, the split data is not limited to splitting the question in text form. For example, data parts can include multimedia, images, and visual effects including highlights and grouping, increase difficulty, beautify, flow, and explanatory messages, etc. As one example in a contest game, a split part could be a weapon that is available only when allowed by the contest time flow.

### Server-Side Measurements

In some embodiments, server-side measurements are applied. When answering-time is an important factor for measuring a participant's performance, accepting the elapsed-time from a participant's device may raise unfairness issues—a malicious user can alter or freeze the participant's own device timer to his or her advantage. Relying on the contest server for timing measurements helps to address this issue. The contest server may send timestamps in all messages including user reply messages. Server-based timestamps may be used to increase transparency and fairness.

### Contest Platform Applications

Techniques described herein apply to many variations. Although specific embodiments are described herein, the online contest format applies to many variations of specific online contests or e-contests including educational exams, e-voting, e-learning, e-polling, and quiz activities. Contests of different types are often organized by government organizations. Examples include high school national exams, student contests, general contests for a variety of scientific fields, and contests for public officer positions.

With e-voting, the process of holding an election electronically, ballots are cast securely and secretly online. Among the advantages of a secure e-voting system are lower error rates in vote counting, no need for physical voter presence, and lower cost. In some embodiments, the process of organizing a secure online contest prevents the early opening of electronically-cast votes. This helps to address election fraud, as all parties involved would not have access to the results until a specific, predefined time in the future. It would also prevent communications bottlenecks that may occur if all votes are cast “just in time.” The possibility for pre-voting (an a-priori electronic vote) or an absentee voting is possible with techniques described herein. An electronic vote is counted only if the voter does not later participate in the physical election procedure.

The techniques described herein also provide a platform for the organization of electronic or online contests. Electronic or online contests have several advantages over traditional contractual contests, including lack of travel expenses and irrelevance of the participant's geographic distribution. The techniques described herein overcome major difficulties typically associated with online contests that require that all competitors must have simultaneous access to the challenge problem, despite possible network congestion or delivery delays. These difficulties are overcome by ensuring that every participant has received the challenge well before the contest starts but cannot access the contest data until the appropriate contest time in accordance with the contest flow time.

The techniques described herein provide a platform for the organization of sealed-bid auction mechanisms (blind auctions). A sealed bid auction is a negotiation mechanism where sellers and buyers intend to come to an agreement on the transaction of a commodity. Each bidder submits a sealed bid stating how much the user is willing to pay and the highest (or the second, or third highest, etc.—depending on the method used) bid wins the auction. The maintenance of secrecy in sealed-bid auctions is essential, as no one should be able to view the bids before the bidding period has ended. The techniques described herein would prevent these problems from arising by making it difficult for anyone to view the bids before the end of the auction, thus enforcing honesty among participants. This helps ensure the fairness of the procedure for the parties involved, which may include governments, citizens, or associations.

The techniques described herein provide a platform for the timed-release of any kind of electronic documents, e.g., personal or public documents, such as strategic decisions, press articles, press releases, or memoirs, etc. that must remain secret until a future time. The techniques described herein allow for the encryption of contest data, which can only be revealed by decrypting the data with the corresponding decryption key at the appointed time, without the sender having to be online at the decryption time, or even to remember a decryption key. The techniques described herein also provide confidentiality by ensuring that the document is accessible to only those authorized to have access to it. The techniques described herein also provide for the timed-release of electronic documents, an important function for businesses, academics, e-governance, and military applications. The timed-release of electronic documents has many applications including application for the public or military sector, where confidential documents or directives must remain secret until a specific date (e.g., coordinates of the next troop move, etc.).

The techniques described herein provide a platform for certain specific types of payment schedules including electronic payment of ordered goods, services, or works. The payment schedule of a financial instrument defines the dates at which payments must occur by one party to another, and is often used in the settlement of loans, bonds, or mortgages. Examples of payment schedules occur in business to business, government to business, or business/government to citizens' transactions. These transactions save valuable time as the payment can be scheduled only once and reoccurring payments can be made until a total amount is paid. In one example, one entity provides another party the total sum of money in encrypted digital currency with future release times such that the payments may be decrypted (and thus usable by a party such as a bank) only at the appropriate dates.

The techniques described herein provide a platform for e-lottery, e-betting, and e-gambling. The techniques described herein can provide increased fairness to games to help ensure that the results correctly rely on enough randomness and are not influenced or manipulated by the entity or other players. As an example, a participant may encrypt the participant's betting-slip or lottery selections using an encryption key using the methods described herein so that the bookmaker or the lottery host does not know the actual selections prior to the end of the event. In a similar manner, participants may add their random seeds to the raffle function in accordance to the techniques described herein such that no party can a-priori know the final seed and thus the random outcome.

The techniques described herein provide a platform for timed-release communication applications. One example allows for the sending of a timed-release wish or gift. Another example allows for sending a message, such as an SMS or email, that is scheduled to be decrypted at a future time, or when a future event occurs.

The techniques described herein provide a platform for a verification system for betting on the outcome of future events, in a manner similar to bitcoin block-chains. If K out of N servers publish a decryption key for an event X, participants who bet and have a favourable outcome from the event will get paid. Using the described techniques, the decrypted keys work as a verification of the outcome of the event. Additional rules may apply to further define that the expected event did not occur until a certain day, e.g., on time t, contest servers will publish a key for the “X event didn't happened before time t.”

The techniques described herein provide a platform for verifying predictions, forecasts, or actions. As an example made possible with these techniques, participants make forecasts without revealing their selection before a designated time-instant. This process can apply to betting and the gambling industry if players do not want to reveal their selection before the event completes. Additionally, the techniques described herein also work as a tool for participants that would like to initially hide their predictions and later prove that they were either correct or not.

Although the foregoing embodiments have been described in some detail for purposes of clarity of understanding, the present invention is not limited to the details provided. There are many alternative ways of implementing the invention. Descriptions of specific process, devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the disclosed embodiments are illustrative and not intended to be limited to the examples described herein and shown, but are to be accorded the scope consistent with the claims.

What is claimed is:

1. The method comprising:
creating a set of encrypted contest data parts, wherein each encrypted contest data part is encrypted using one of a set of encryption keys and capable of being decrypted using one of a set of corresponding decryption keys;
announcing a contest starting time to a group of participants; and
making available for distribution the set of encrypted contest data parts to the group of participants.

2. The method of claim 1, further comprising:
transmitting to the group of participants each decryption key in accordance to a contest time flow.

3. The method of claim 1, further comprising
transmitting to the group of participants a set of messages in accordance to a contest time flow, wherein each message comprises an unique identifier relating to one of the encrypted contest data parts and the corresponding decryption key capable of decrypting the encrypted contest data part.

4. The method of claim 2, further comprising:
decrypting each encrypted contest data part upon receiving the corresponding decryption key.

5. The method of claim 1, wherein each encryption key is unique.

6. The method of claim 1, wherein the distribution is performed via a content delivery network.

7. The method of claim 1, wherein the distribution is performed via a content delivery network using the File Transfer Protocol.

8. The method of claim 1, wherein the contest time flow follows a timed-release policy.

9. The method of claim 1, wherein the contest time flow follows an event-release policy.

10. The method of claim 1, wherein the contest data part includes a contest question.

11. The method of claim 1, wherein the contest data part includes a portion of a multi-part contest question.

12. The method of claim 1, wherein the set of encrypted contest data parts includes an encrypted question, an encrypted answer, encrypted multimedia information, and an encrypted question hint.

13. A system comprising:
a memory;
a network interface; and
a processor configured to:
create a set of encrypted contest data parts, wherein each encrypted contest data part is encrypted using one of a set of encryption keys and capable of being decrypted using one of a set of corresponding decryption keys;
announce, via the network interface, a contest starting time to a group of participants;
make available for distribution, via the network interface, the set of encrypted contest data parts to the group of participants; and
transmit to the group of participants, via the network interface, each decryption key in accordance to a contest time flow.

14. The system of claim 13, wherein the processor is further configured to transmit to the group of participants a set of messages in accordance to the contest time flow, wherein each message comprises an unique identifier relating to one of the encrypted contest data parts and the corresponding decryption key capable of decrypting the encrypted contest data part.

15. The system of claim 13, wherein the processor is further configured to decrypt each contest data part upon receiving the corresponding decryption key.

16. The system of claim 13, wherein the distribution of the set of encrypted contest data parts is made available to the group of participants with a content delivery network.

17. The system of claim 13, wherein the set of encrypted contest data parts includes an encrypted question, an encrypted answer, encrypted multimedia information, and an encrypted question hint.

18. A method comprising:
receiving from a contest data server a set of encrypted contest data parts, wherein each encrypted contest data part is encrypted using one of a set of encryption keys and capable of being decrypted using one of a set of corresponding decryption keys; and
receiving from a contest control server a contest starting time.

19. The method of claim 18, further comprising:
receiving from a content key server each decryption key in accordance to a contest time flow; and
decrypting each encrypted contest data part upon receiving the corresponding decryption key.

20. The method of claim 18, further comprising:
receiving from a content key server a set of messages in accordance to a contest time flow, wherein each message comprises an unique identifier relating to one of the encrypted contest data parts and the corresponding decryption key capable of decrypting the encrypted contest data part; and
decrypting each encrypted contest data part upon receiving the corresponding decryption key.
